(19) United States
(12) Patent Application Publication
(10) Pub. No.: US 2013/0097577 A1
(43) Pub. Date: Apr. 18, 2013

(54) Impedance Compensation For A Differential Pair Of Conductive Paths

(71) Applicants: William T. Byrne, Raleigh, NC (US); Robert J. Christopher, Chapel Hill, NC (US); Paul D. Kangas, Raleigh, NC (US); Pravin S. Patel, Cary, NC (US); Daniel M. Ranck, Cary, NC (US)

(72) Inventors: William T. Byrne, Raleigh, NC (US); Robert J. Christopher, Chapel Hill, NC (US); Paul D. Kangas, Raleigh, NC (US); Pravin S. Patel, Cary, NC (US); Daniel M. Ranck, Cary, NC (US)

(73) Assignee: INTERNATIONAL BUSINESS MACHINES CORPORATION, ARMONK, NY (US)

(21) Appl. No.: 13/275,865

(22) Filed: Oct. 18, 2011

(51) Int. Cl. G06F 17/50

(52) U.S. Cl. 716/137

(57) ABSTRACT

Methods, apparatus, and products for impedance compensation for a differential pair of conductive paths, including: determining the differential impedance and conductor geometry for the differential pair of conductive paths; determining the path length differential between the conductive paths in the differential pair of conductive paths; determining a centerline path to follow for a shorter conductive path in the differential pair of conductive paths, wherein the centerline path lengths the shorter conductive path such that the length of each conductive path in the differential pair of conductive paths is identical within a predetermined threshold; determining a number of subdivisions of one or more serpentine segments on one of the conductive paths in the differential pair; and determining, in dependence upon the differential impedance at each of the subdivisions of the one or more serpentine segments, a serpentine segment path width for the serpentine segment.

### BACKGROUND OF THE INVENTION

1. Field of the Invention

The field of the invention is data processing, or, more specifically, methods, apparatus, and products for impedance compensation for a differential pair of conductive paths.

2. Description of Related Art

In a differential pair of conductive paths, differential impedance is a function of line width and line spacing, among other things. High-speed differential pairs typically have a phase matching requirement, meaning that the lengths of the two conductive paths that comprise the differential pair must match within some tolerance. Frequently, differential pairs cannot follow a straight line across a printed circuit board (‘PCB’) from their source to their destination, and as such, the conductive paths of the differential pair must turn to avoid obstacles on the PCB. Each turn causes one of the conductive paths in the differential pair to lengthen with respect to the conductive path. The aggregate length mismatch between the two conductive paths comprising the differential pair may be compensated by inserting a serpentined section into the shorter line, thereby adding the missing length. Because the separation of the conductive paths changes and the width of the conductive path does not change, the differential impedance of the serpentined section does not match the differential impedance of the remaining segments of the conductive paths, giving rise to reflection and a degradation of signal quality.

### SUMMARY OF THE INVENTION

Methods, apparatus, and products for impedance compensation for a differential pair of conductive paths, including: determining the differential impedance for the differential pair of conductive paths, wherein each conductive path has a predetermined width; determining the geometry of one or more serpentine segments on one of the conductive paths in the differential pair; and determining, in dependence upon the differential impedance at each of the one or more serpentine segments, a serpentine segment path width at each of the one or more serpentine segments of the conductive paths in the differential pair. The methods, apparatus, and products described herein are useful in edge-coupled stripline and edge-coupled microstrip structures.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful in impedance compensation for a differential pair of conductive paths according to embodiments of the present invention.

FIG. 2A sets forth a block diagram of a prior art differential pair of conductive paths that connect two computing components.

FIG. 2B sets forth a block diagram of a prior art differential pair of conductive paths that connect two computing components.

FIG. 3 sets forth a block diagram of a differential pair of conductive paths that connect two computing components in accordance with embodiments of the present invention.

FIG. 4 sets forth a block diagram of a conductive path that is transitioning between a narrow path width to a wider path width in accordance with embodiments of the present invention.

FIG. 5 sets forth a flow chart illustrating an exemplary method for impedance compensation for a differential pair of conductive paths according to embodiments of the present invention.

### DETAILED DESCRIPTION OF EXEMPLARY EMBODIMENTS

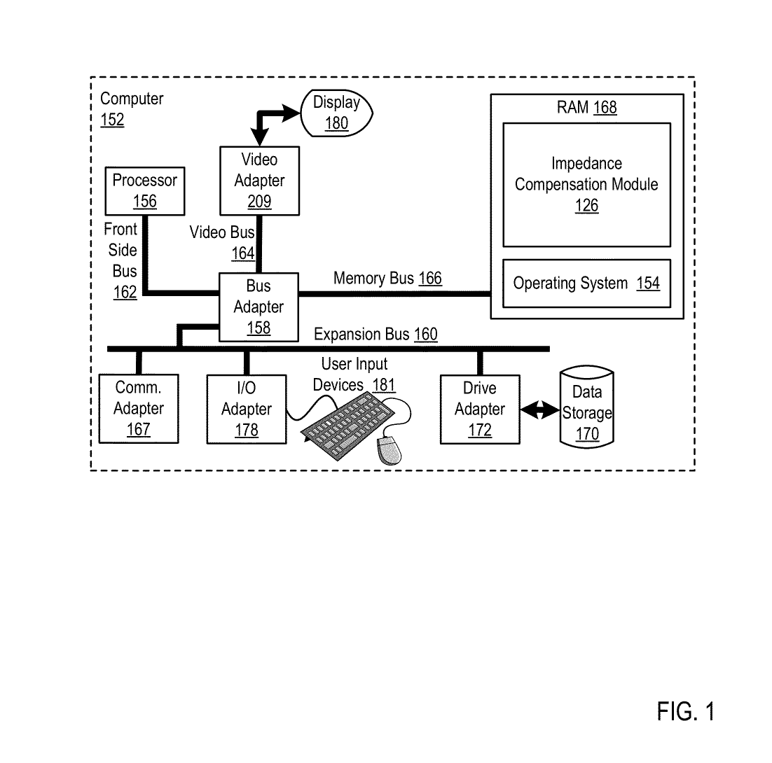

Example methods, apparatus, and products for impedance compensation for a differential pair of conductive paths in accordance with the present invention are described with reference to the accompanying drawings, beginning with FIG. 1.

FIG. 1 sets forth a block diagram of automated computing machinery comprising an exemplary computer (152) useful in impedance compensation for a differential pair of conductive paths according to embodiments of the present invention. The computer (152) of FIG. 1 includes at least one computer processor (156) or ‘CPU’ as well as random access memory (168) (RAM') which is connected through a high speed memory bus (166) and bus adapter (158) to processor (156) and to other components of the computer (152).

Stored in RAM (168) is an impedance compensation module (126), a module of computer program instructions for impedance compensation for a differential pair of conductive paths according to embodiments of the present invention. The impedance compensation module (126) includes computer program instructions that, when executed by the computer processor (156), cause the computer (152) to carry out the step of determining the differential impedance and conductor geometry for the differential pair of conductive paths. The conductor geometry includes, for example, the path through which the differential pair of conductive paths may run. The path through which the differential pair of conductive paths may run may be impacted, for example, by other computing components that the differential pair of conductive paths must circumvent. The conductor geometry may also include the width of each conductive path, the separation between each path, and so on.

Determining the differential impedance for the differential pair of conductive paths may be carried out, for example, through the use of a field solver used in the design of an integrated circuit or printed circuit board. Information such as the separation of each conductive path in the differential pair and the width of each path in the conductive pair may be used as input to the field solver to determine the differential impedance for the differential pair of conductive paths. Determining the differential impedance for the differential pair of conductive paths may be carried out by receiving a predetermined target differential impedance for the differential pair of conductive paths. The predetermined target differential impedance for the differential pair of conductive paths may be received, for example, from a manufacturer, system designer, and so on. The predetermined target differential impedance represents the differential impedance that is desired between the differential pair of conductive paths. In order to achieve the predetermined target differential impedance, the conductive paths may be separated by a distance necessary to achieve the predetermined target differential impedance, the conductive paths may be designed to be of a width needed to achieve predetermined target differential impedance, or any combination thereof.

Determining the differential impedance and conductor geometry for the differential pair of conductive paths may also include determining the conductor geometry for the differential pair of conductive paths in dependence upon the predetermined target differential impedance for the differential pair of conductive paths. Determining the conductor geometry for the differential pair of conductive paths in dependence upon the predetermined target differential impedance for the differential pair of conductive paths may be carried out, for example, by determining the amount of separation between the conductive paths that is necessary to achieve the predetermined target differential impedance, by determining the width of each conductive path that is needed to achieve predetermined target differential impedance, and so on.

The impedance compensation module (126) also includes computer program instructions that, when executed by the computer processor (156), cause the computer (152) to carry out the step of determining the path length differential between the conductive paths in the differential pair of conductive paths. The length of each conductive path in the differential pair of conductive paths may not be identical. The path length differential between the conductive paths in the differential pair of conductive paths represents this difference in path length between the conductive paths in the differential pair of conductive paths. In the example of FIG. 1, determining the path length differential between the conductive paths in the differential pair of conductive paths may therefore be carried out by subtracting the path length of the shorter conductive path from the path length of the longer conduction path.

The impedance compensation module (126) also includes computer program instructions that, when executed by the computer processor (156), cause the computer (152) to carry out the step of determining a centerline path to follow for a shorter conductive path in the differential pair of conductive paths. The centerline path represents the center of the conductive path for the entire length of the conductive path. The centerline path lengthens the shorter conductive path such that the length of each conductive path in the differential pair of conductive paths is identical within a predetermined threshold. Consider an example in which the shorter conductive path of the differential pair is 2 millimeters and the longer conductive path of the differential pair is 2.2 millimeters. In such an example, because the length of each conductive path should be identical, the shorter conductive path would need to be lengthened by 0.2 millimeters.

The impedance compensation module (126) also includes computer program instructions that, when executed by the computer processor (156), cause the computer (152) to carry out the step of determining a number of subdivisions of one or more serpentine segments on one of the conductive paths in the differential pair. Determining a number of subdivisions of one or more serpentine segments on one of the conductive paths in the differential pair may be carried out, for example, by determining a number of subdivisions of one or more serpentine segments on one of the conductive paths in the differential pair such that the length of each conductive path is identical within a predetermined threshold. For example, determining a number of subdivisions of one or more serpentine segments on one of the conductive paths in the differential pair may include first determining the length of each conductive path of the differential pair. Consider an example in which the shorter conductive path of the differential pair is 2 millimeters and the longer conductive path of the differential pair is 2.2 millimeters. In such an example, because the length of each conductive path should be identical, the shorter conductive path would need to be lengthened by 0.2 millimeters. Determining a number of subdivisions of one or more serpentine segments on one of the conductive paths in the differential pair may therefore further be carried out by determining a number of subdivisions of one or more serpentine segments that adds a required amount of length to the shorter conductive path such that the lengths of each conductive path in the differential pair is identical within a predetermined threshold.

The impedance compensation module (126) also includes computer program instructions that, when executed by the computer processor (156), cause the computer (152) to carry out the step of determining, in dependence upon the differential impedance at each of the one or more serpentine segments, a serpentine segment path width at each of the one or more serpentine segments of the conductive paths in the differential pair. The differential impedance between two conductive paths in a differential pair is a function of the distance between each path. When one of the conductive paths has one or more serpentine segments, the distance between the two conductive paths is not uniform. As such, the differential impedance between two conductive paths at a point at which one of the conductive paths has serpentine segments is different that the differential impedance between two conductive paths when neither path has a serpentine segment. In order to create uniform differential impedance at the point at which one of the conductive paths has serpentine segments, the width of each conductive path may be altered given that the differential impedance between two conductive paths is also a function of the width of each conductive path. Determining a serpentine segment path width at each of the one or more serpentine segments of the conductive paths in the differential pair may therefore be carried out by determining a serpentine segment path width that causes the differential impedance to be consistent within a predetermined threshold at all points along each conductive path.

Also stored in RAM (168) is an operating system (154). Operating systems useful impedance compensation for a differential pair of conductive paths according to embodiments of the present invention include UNIX™, Linux™, Microsoft XP™, AIX™, IBM's i5/OS™, and others as will occur to those of skill in the art. The operating system (154) and impedance compensation module (126) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for impedance compensation for a differential pair of conductive paths according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with other computers and for data communications with a data communications network. Such data communications may be carried out serially through RS-232 connections, through external buses such as a Universal Serial Bus (‘USW’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for impedance compensation for a differential pair of conductive paths according to embodiments of the present invention include modems for wired dial-up communications, Ethernet (IEEE 802.3) adapters for wired data communications network communications, and 802.11 adapters for wireless data communications network communications.

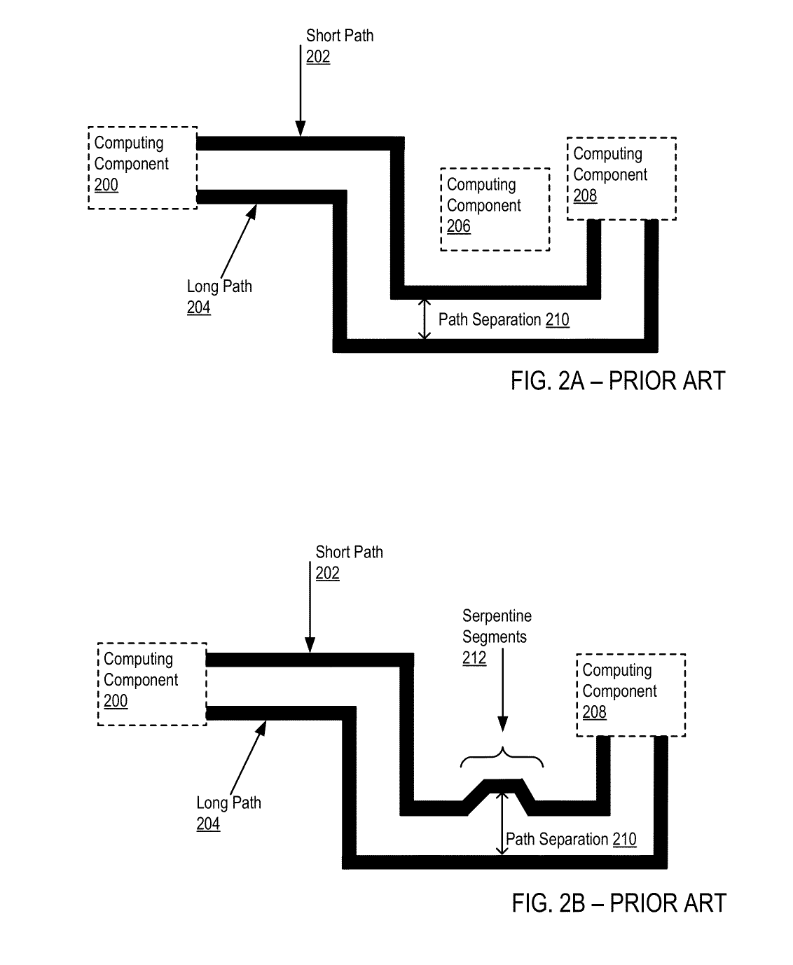

For further explanation, FIG. 2A sets forth a block diagram of a differential pair of conductive paths (202, 204) that connect two computing components (200, 208). In the example of FIG. 2A, the conductive paths (202, 204) may be embodied, for example, as a trace on a printed circuit board (PCB'). The conductive paths (202, 204) of the differential pair may be utilized to transmit electrical signals between the two computing components (200, 208) that are connected by the differential pair. In the example of FIG. 2A, because the conductive paths (202, 204) form a differential pair, the conductive paths (202, 204) may be used for differential signaling in which electrical information is exchanged by sending complimentary signals over each of the conductive paths (202, 204). In such an example, a higher voltage on one path represents a particular logical value while a higher voltage on the other path represents a different logical value, such as a logical ‘0’ or logical ‘1.’

In the example of FIG. 2A, the conductive paths (202, 204) must be routed around another computing component (206). The example depicted in FIG. 2A is especially common in the context of a PCB, as traces frequently must be routed around the other computing components that are mounted on the PCB. In such an example, the routing of the conductive paths (202, 204) around other computing components (206) may cause each conductive path (202, 204) to be of a different length. In FIG. 2A, one conductive path is the short conductive path (202) while the other conductive path is the long conductive path (204). As such, the distance that an electrical signal must travel when the signal is carried over the long conductive path (204) is greater than the distance that an electrical signal must travel when the signal is carried over the short conductive path (202), thereby creating the opportunity for the electrical signals to become out-of-phase. In order to address out-of-phase signals, the length of the shorter path (202) may be extended to match the length of the longer path (204) within a certain tolerance. For example, the length of the shorter path (202) may be extended to match the length of the longer path (204) by including ‘serpentine segments’ into the shorter path (202).

For further explanation, FIG. 2B sets forth a block diagram of a differential pair of conductive paths (202, 204) that connect two computing components (200, 208). The example of FIG. 2B is similar to the example of FIG. 2A, although the computing component (206) that the conductive paths (202, 204) must be routed around is not depicted in FIG. 2B. In the example of FIG. 2B, however, the short path (202) has been altered to include serpentine segments (212) designed to add additional length to the short path (202). The serpentine segments (212) may be embodied, for example, as a part of the trace the forms the conductive path (202) with a geometry that causes the length of the short path (202) to be the same as the length of the long path (204) within an acceptable tolerance. Through the use of serpentine segments (212) the length of the shorter path (202) may be extended to match the length of the longer path (204) such that signals sent over each path (202, 204) can remain in phase.

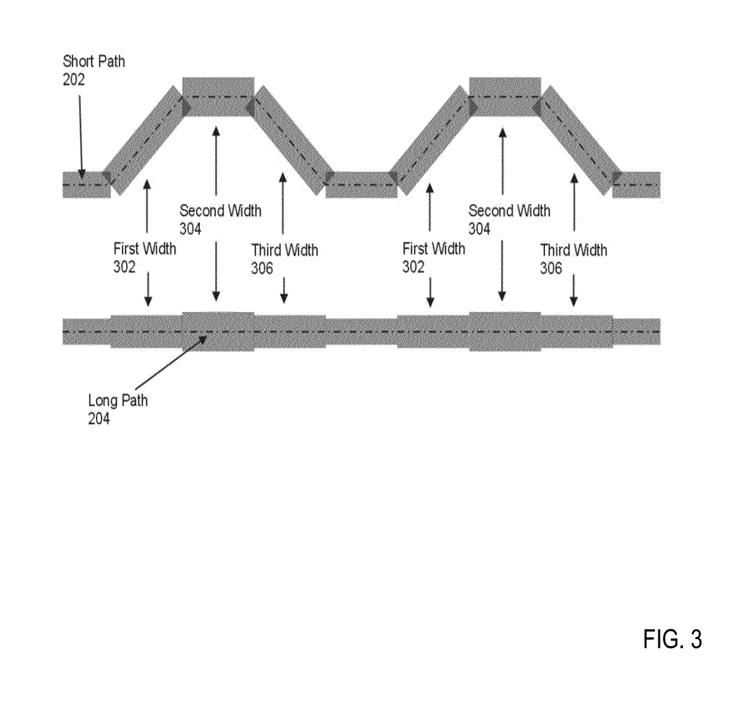

In the example of FIG. 2B, however, the path separation (210) between the short path (202) and the long path (204) is not uniform. The path separation (210) of the conductive paths (202, 204) of FIG. 2B, which represents the distance between the two conductive paths (202, 204), is impacted by the serpentine segments (212) on the short path (202). In the example of FIG. 2A, however, the path separation (210) of the conductive paths (202, 204) is uniform. Because differential impedance across a differential pair is, in part, a function of the distance between the two signal lines of the differential pair, the inclusion of the serpentine segments (212) on the short path (202) causes the differential impedance across the differential pair of conductive paths (202, 204) to be non-uniform. FIG. 3 sets forth a solution to the problem of having the differential impedance across the differential pair of conductive paths (202, 204) being non-uniform.

For further explanation, FIG. 3 sets forth a block diagram of a differential pair of conductive paths (202, 204) that can connect two computing components. The example of FIG. 3 is similar to the example of FIG. 2B as the short conductive path (202) includes serpentine segments such that the length of the short conductive path (202) is within a predetermined threshold of the long conductive path (204). The example of FIG. 3 is further similar to the example of FIG. 2B as the serpentine segments of the short conductive path (202) creates non-uniform path separation between the short conductive path (202) and the long conductive path (204) of the differential pair, thereby causing impedance across the differential pair of conductive paths (202, 204) to be non-uniform.

In the example of FIG. 3, however, the short conductive path (202) and the long conductive path (204) have non-uniform path widths. Differential impedance across differential pair of conductive paths (202, 204) is not only a function of the distance between the two paths such as the path separation. Differential impedance across differential pair of conductive paths (202, 204) is also a function of the width of each conductive path (202, 204). In the example of FIG. 3, therefore, the width of each conductive path (202, 204) is non-uniform so as to produce uniform differential impedance across differential pair of conductive paths (202, 204). For example, the short conductive path (202) and the long conductive path (204) are of a first width (302) at a first portion of the serpentine segments, a second width (304) at a second portion of the serpentine segments, and a third width (306) at a third portion of the serpentine segments. The width (302, 304, 306) of each segment is calculated so as to produce uniform differential impedance across the differential pair, within an acceptable threshold, given the physical properties of the differential pair. Examples of relevant physical properties of the differential pair include, for example, the distance between each segment of the differential pair, the characteristic impedance of each conductive path (202, 204), and so on. Readers will appreciate that although the example depicted in FIG. 3 illustrates a situation in which the path separation increases, path separation may also decrease. Embodiments of the present invention are contemplated in which the path separation increases, in which the path separation decreases, or any combination thereof.

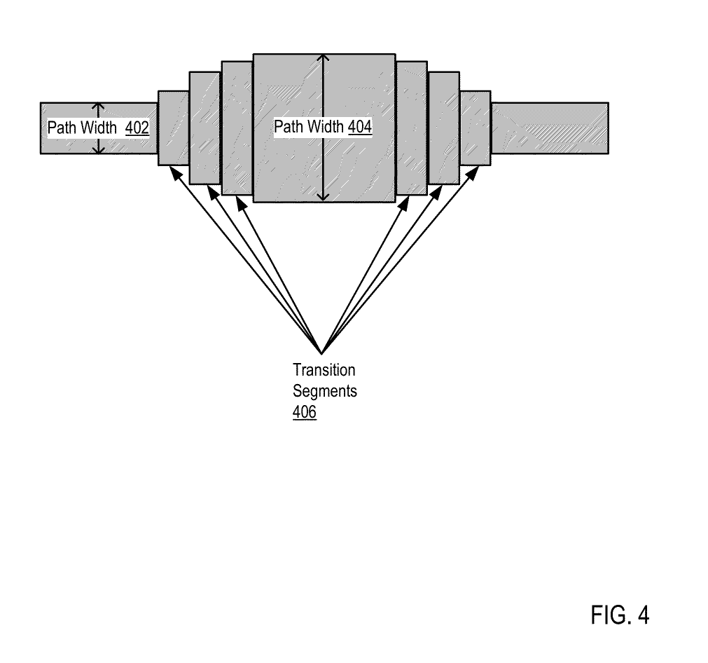

For further explanation, FIG. 4 sets forth a block diagram of a conductive path that is transitioning between a narrow path width (402) to a wider path width (404). The example of FIG. 4 illustrates that a conductive path of different widths at various segments of the conductive path may be constructed such that a plurality of transition segments (406) are used to transition, over some distance, from a narrow path width (402) to a wider path width (404). In such an example, the number of transition segments (406), the size of each transition segment (406), and other physical aspects of each transition segment (406) may be accounted for when determining the path widths (402, 404) that are necessary to achieve uniform differential impedance across a differential pair.

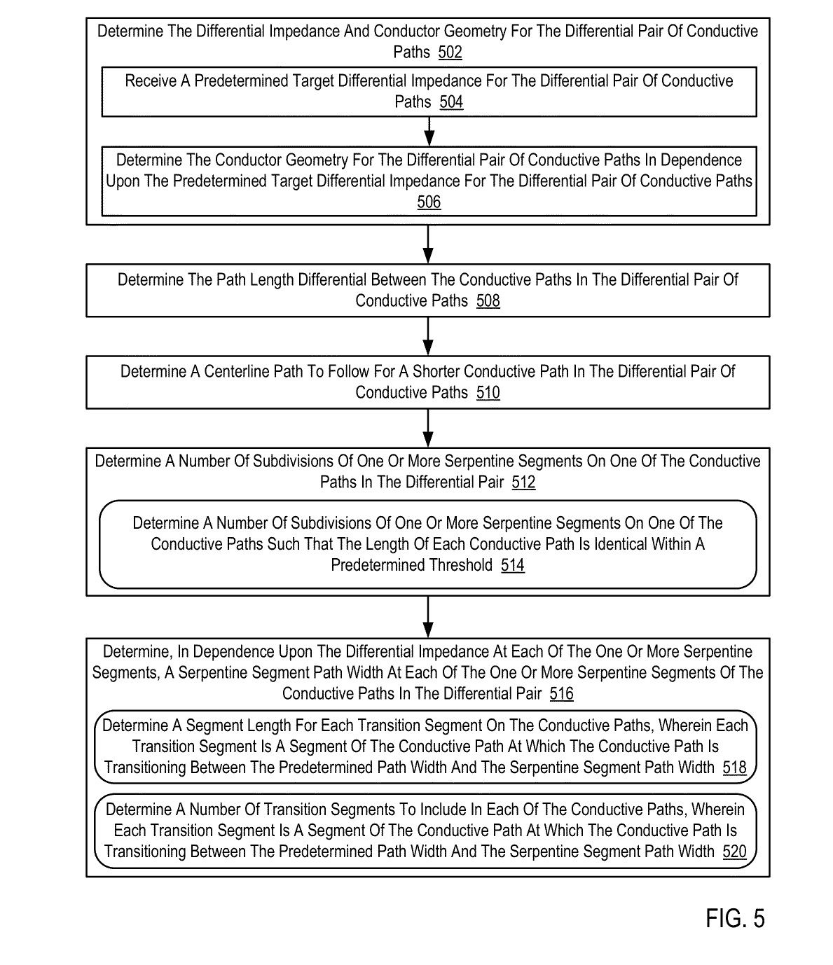

For further explanation, FIG. 5 sets forth a flow chart illustrating an exemplary method for impedance compensation for a differential pair of conductive paths according to embodiments of the present invention. The example method of FIG. 5 includes determining (502) the differential impedance and conductor geometry for the differential pair of conductive paths. In the example method of FIG. 5, the conductor geometry includes, for example, the path through which the differential pair of conductive paths may run. The path through which the differential pair of conductive paths may run may be impacted, for example, by other computing components that the differential pair of conductive paths must circumvent. In the example method of FIG. 5, the conductor geometry may also include the width of each conductive path, the separation between each path, and so on.

In the example of FIG. 5, determining (502) the differential impedance for the differential pair of conductive paths may be carried out, for example, through the use of a field solver used in the design of an integrated circuit or printed circuit board. In the example method of FIG. 5, information such as the separation of each conductive path in the differential pair and the width of each path in the conductive pair may be used as input to the field solver to determine (502) the differential impedance for the differential pair of conductive paths.

In the example method of FIG. 5, determining (502) the differential impedance for the differential pair of conductive paths may be carried out by receiving (504) a predetermined target differential impedance for the differential pair of conductive paths. The predetermined target differential impedance for the differential pair of conductive paths may be received, for example, from a manufacturer, system designer, and so on. The predetermined target differential impedance represents the differential impedance that is desired between the differential pair of conductive paths. In order to achieve the predetermined target differential impedance, the conductive paths may be separated by a distance necessary to achieve the predetermined target differential impedance, the conductive paths may be designed to be of a width needed to achieve predetermined target differential impedance, or any combination thereof.

In the example of FIG. 5, determining (502) the differential impedance and conductor geometry for the differential pair of conductive paths may also include determining (506) the conductor geometry for the differential pair of conductive paths in dependence upon the predetermined target differential impedance for the differential pair of conductive paths. Determining (506) the conductor geometry for the differential pair of conductive paths in dependence upon the predetermined target differential impedance for the differential pair of conductive paths may be carried out, for example, by determining the amount of separation between the conductive paths that is necessary to achieve the predetermined target differential impedance, by determining the width of each conductive path that is needed to achieve predetermined target differential impedance, and so on.

The example method of FIG. 5 also includes determining (508) the path length differential between the conductive paths in the differential pair of conductive paths. As described above, the length of each conductive path in the differential pair of conductive paths may not be identical. The path length differential between the conductive paths in the differential pair of conductive paths represents this difference in path length between the conductive paths in the differential pair of conductive paths. In the example of FIG. 5, determining (508) the path length differential between the conductive paths in the differential pair of conductive paths may therefore be carried out by subtracting the path length of the shorter conductive path from the path length of the longer conduction path.

The example method of FIG. 5 also includes determining (510) a centerline path to follow for a shorter conductive path in the differential pair of conductive paths. In the example of FIG. 5, the centerline path represents the center of the conductive path for the entire length of the conductive path. The centerline path of FIG. 5 lengthens the shorter conductive path such that the length of each conductive path in the differential pair of conductive paths is identical within a predetermined threshold. Consider an example in which the shorter conductive path of the differential pair is 2 millimeters and the longer conductive path of the differential pair is 2.2 millimeters. In such an example, because the length of each conductive path should be identical, the shorter conductive path would need to be lengthened by 0.2 millimeters.

The example method of FIG. 5 also includes determining (512) a number of subdivisions of one or more serpentine segments on one of the conductive paths in the differential pair. In the example method of FIG. 5, determining (512) a number of subdivisions of one or more serpentine segments on one of the conductive paths in the differential pair may be carried out, for example, by determining (514) a number of subdivisions of one or more serpentine segments on one of the conductive paths in the differential pair such that the length of each conductive path is identical within a predetermined threshold. For example, determining (514) a number of subdivisions of one or more serpentine segments on one of the conductive paths in the differential pair may include first determining the length of each conductive path of the differential pair. Consider an example in which the shorter conductive path of the differential pair is 2 millimeters and the longer conductive path of the differential pair is 2.2 millimeters. In such an example, because the length of each conductive path should be identical, the shorter conductive path would need to be lengthened by 0.2 millimeters. Determining (514) a number of subdivisions of one or more serpentine segments on one of the conductive paths in the differential pair may therefore further be carried out by determining a number of subdivisions of one or more serpentine segments that adds a required amount of length to the shorter conductive path such that the lengths of each conductive path in the differential pair is identical within a predetermined threshold.

The example method of FIG. 5 also includes determining (516), in dependence upon the differential impedance at each of the one or more serpentine segments, a serpentine segment path width at each of the one or more serpentine segments of the conductive paths in the differential pair. As described above, the differential impedance between two conductive paths in a differential pair is a function of the distance between each path. When one of the conductive paths has one or more serpentine segments, the distance between the two conductive paths is not uniform. As such, the differential impedance between two conductive paths at a point at which one of the conductive paths has serpentine segments is different that the differential impedance between two conductive paths when neither path has a serpentine segment. In order to create uniform differential impedance at the point at which one of the conductive paths has serpentine segments, the width of each conductive path may be altered given that the differential impedance between two conductive paths is also a function of the width of each conductive path. Determining (516) a serpentine segment path width at each of the one or more serpentine segments of the conductive paths in the differential pair may therefore be carried out by determining (516) a serpentine segment path width that causes the differential impedance to be consistent within a predetermined threshold at all points along each conductive path.

In the example method of FIG. 5, determining (516) a serpentine segment path width at each of the one or more serpentine segments can include determining (518) a segment length for each transition segment on the conductive paths, wherein each transition segment is a segment of the conductive path at which the conductive path is transitioning between the predetermined path width and the serpentine segment path width. For example, consider the conductive path depicted in FIG. 4 that includes three transition segments (406) that are used to transition the path width from an initial path width (402) to a resultant path width (404). In such an example, determining (518) a segment length for each transition segment (406) may be carried out, for example, by setting the maximum amount of path width increase per transition segment to a predetermined amount and determining the number of transition segments that would be needed to transition the path width from an initial path width (402) to a resultant path width (404).

For example, if the initial path width (402) is 2 millimeters, the subsequent path width is (404) 2.2 millimeters, and the predetermined maximum amount of path width increase per transition segment is 0.05 millimeters, then three transition segments would be needed. The path width of the first transition segment would be 2.05 millimeters, the path width of the second transition segment would be 2.10 millimeters, and the path width of the third transition segment would be 2.15 millimeters. By placing these transition segments between a conductive path of 2.0 millimeters and a conductive path of 2.2 millimeters, the width of the conductive path could be gradually increased.

In the example method of FIG. 5, determining (516) a serpentine segment path width at each of the one or more serpentine segments can also include determining (520) a number of transition segments to include in each of the conductive paths, wherein each transition segment is a segment of the conductive path at which the conductive path is transitioning between the predetermined path width and the serpentine segment path width. For example, consider the conductive path depicted in FIG. 4 that includes transition segments (406) that are used to transition the path width from an initial path width (402) to a resultant path width (404). In such an example, determining (520) a number of transition segments to include in each of the conductive path may be carried out, for example, by setting the maximum amount of path width increase per transition segment to a predetermined amount and determining the number of transition segments that would be needed to transition the path width from an initial path width (402) to a resultant path width (404).

For example, if the initial path width (402) is 2 millimeters, the subsequent path width is (404) 2.2 millimeters, and the predetermined maximum amount of path width increase per transition segment is 0.05 millimeters, then three transition segments would be needed. The first transition segment would transition the path to a path width of 2.05 millimeters, the second transition segment would transition the path to a path width of 2.10 millimeters, and the third transition segment would transition the path to a path width of 2.15 millimeters. By placing these transition segments between a conductive path of 2.0 millimeters and a conductive path of 2.2 millimeters, the width of the conductive path could be gradually increased.

Readers will appreciate that although many of the examples depicted in the Figures illustrate a situation in which the path separation increases, path separation may also decrease. Embodiments of the present invention are contemplated in which the path separation increases, in which the path separation decreases, or any combination thereof. Furthermore, although many of the examples depicted in the Figures illustrate a situation in which segments of the conductive paths are linear, embodiments of the present invention are contemplated in which segments of the conductive paths are curved or otherwise non-linear. Likewise, embodiments of the present invention are contemplated in which segment lengths are infinitesimally short such that the conductive paths are embodied as smooth, continuously varying line geometries.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of impedance compensation for a differential pair of conductive paths on a printed circuit board, the method comprising:
establishing, based upon a predetermined target differential impedance for a differential pair of conductive paths, a conductor geometry for the differential pair, the differential pair comprising two conductive paths driven by a differential signal between computing components on a printed circuit board of a computer, the conductor geometry characterized by different path lengths for the conductive paths in the differential pair with one path length shorter than the other;
lengthening with inserted serpentine segments the shorter conductive path to the same length as the longer conductive path, each serpentine segment characterized with a subdivision of both conductive paths
establishing, based upon the predetermined target differential impedance, a segment path width for each subdivision of the conductive paths.

2. (canceled)

3. The method of claim 1 wherein establishing, a segment path width further comprises establishing a segment length for each transition segment on the conductive paths, wherein each transition segment is a segment of the conductive paths at which the conductive paths are transitioning between a predetermined path width and the segment path width.

4. The method of claim 1 wherein establishing, a segment path width further comprises establishing a number of transition segments in each of the conductive paths, wherein each transition segment is a segment of the conductive paths at which the conductive paths are transitioning between a predetermined path width and the segment path width.

5. (canceled)

6. (canceled)

7. An apparatus for impedance compensation for a differential pair of conductive paths on a printed circuit board, the apparatus comprising a computer processor, a computer memory operatively coupled to the computer processor, the computer memory having disposed within it computer program instructions that, when executed by the computer processor, cause the apparatus to carry out the steps of:
establishing, based upon a predetermined target differential impedance for a differential pair of conductive paths, a conductor geometry for the differential pair, the differential pair comprising two conductive paths driven by a differential signal between computing components on a printed circuit board of a computer, the conductor geometry characterized by different path lengths for the conductive paths in the differential pair with one path length shorter than the other;
lengthening with inserted serpentine segments the shorter conductive path to the same length as the longer conductive path, each serpentine segment characterized with a subdivision of both conductive paths;
establishing, based upon the predetermined target differential impedance, a segment path width for each subdivision of the conductive paths.

8. (canceled)

9. The apparatus of claim 7 wherein establishing, a segment path width further comprises establishing a segment length for each transition segment on the conductive paths, wherein each transition segment is a segment of the conductive paths at which the conductive paths are transitioning between a predetermined path width and the segment path width.

10. The apparatus of claim 7 wherein establishing, a segment path width further comprises establishing a number of transition segments in each of the conductive paths, wherein each transition segment is a segment of the conductive paths at which the conductive paths are transitioning between a predetermined path width and the segment path width.

11. (canceled)

12. (canceled)

13. A computer program product for impedance compensation for a differential pair of conductive paths, the computer program product disposed upon a computer readable storage medium, the computer program product comprising computer program instructions that, when executed, cause a computer to carry out the steps of:
establishing, based upon a predetermined target differential impedance for a differential pair of conductive paths, a conductor geometry for the differential pair, the differential pair comprising two conductive paths driven by a differential signal between computing components on a printed circuit board of a computer, the conductor geometry characterized by different path lengths for the conductive paths in the differential pair with one path length shorter than the other;
lengthening with inserted serpentine segments the shorter conductive path to the same length as the longer conductive path, each serpentine segment characterized with a subdivision of both conductive paths
establishing, based upon the predetermined target differential impedance, a segment path width for each subdivision of the conductive paths.

14. (canceled)

15. The computer program product of claim 13 wherein establishing, a segment path width further comprises establishing a segment length for each transition segment on the conductive paths, wherein each transition segment is a segment of the conductive paths at which the conductive paths are transitioning between a predetermined path width and the segment path width.

16. The computer program product of claim 13 wherein establishing, a segment path width further comprises establishing a number of transition segments in each of the conductive paths, wherein each transition segment is a segment of the conductive paths at which the conductive paths are transitioning between a predetermined path width and the segment path width.

17. (canceled)

18. (canceled)

19. (canceled)

20. (canceled)

21. The method of claim 1 wherein establishing a segment path width further comprises establishing a segment path width based upon a differential impedance at each of the characterizing subdivisions of the conductive paths.

22. The apparatus of claim 7 wherein establishing a segment path width further comprises establishing a segment path width based upon a differential impedance at each of the characterizing subdivisions of the conductive paths.

23. The computer program product of claim 13 wherein establishing a segment path width further comprises establishing a segment path width based upon a differential impedance at each of the characterizing subdivisions of the conductive paths.
